(19) United States
(12) Patent Application Publication
(10) Pub. No.: US 2004/0143411 A1
(43) Pub. Date: Jul. 22, 2004

(54) Test handling apparatus and method

(76) Inventor: Jie Wu, Singapore (SG)

Correspondence Address: LAWRENCE N. GINSBERG, 21 SAN ANTONIO, NEWPORT BEACH, CA, 92660-9112, US

(21) Appl. No.: 10/750,981

(22) Filed: Jan. 2, 2004

Related U.S. Application Data
(63) Continuation of application No. PCT/SG02/00155, filed on Jul. 5, 2002.

(30) Foreign Application Priority Data
Jul. 6, 2001 (SG) 200104055-9

(51) Int. Cl. G06F 19/00

(52) U.S. Cl. 702/117; 324/765; 324/158.1

(57) ABSTRACT

A test handling apparatus for supplying electronic devices to a tester for testing comprises a tester interface for communicating with the tester; at least two device interfaces each of which is connectable to the tester interface through a first connection, and each of which is connectable to a corresponding group of electronic devices through a second connection, one of the first and the second connections is alternately connectable. A corresponding method comprises connecting a first group of electronic devices to a tester interface for testing; disconnecting the first group of electronic devices from the tester interface upon completion of the testing; connecting a second group of electronic devices to the tester interface for testing and disconnecting the second group of electronic devices from the tester interface upon completion of the testing. Higher operation throughput can be obtained without substantially increasing the speed of a handler.

### FIELD OF THE INVENTION

This invention relates to a test handling apparatus and a test handling method. In particular, it relates to a test handling apparatus in or for a test handler for testing electronic devices and a method of operating a test handling apparatus.

### BACKGROUND OF THE INVENTION

Test handling apparatus are used for automatically supplying electronic devices, such as semiconductor ICs or other electronic components, to electrical testers for testing. A test handling apparatus typically forms part of an overall test handler which also includes an input section for loading a plurality of test trays on which electronic devices are stored, a testing section electrically connected to a tester, and an output section for unloading the plurality of test trays. Electronic devices are loaded to the testing sections, such as test sites, normally in one group at a time, depending on the test configurations of different devices. Typical test setups may be for one, two or four devices per group for testing at one time, referred to as “single-site”, “dual-site” or “quad-site” tests respectively. A “device ready” signal is then sent to the tester to start the testing. The handler at the same time stops loading the electronic devices and waits for the testing to be completed. Upon completion of the testing, the tester pauses, and sends back a “testing completed” signal to the handler. The handler then retrieves the tested group of electronic devices from the testing section and subsequently supplies the next group of electronic devices to the testing section to continue the testing. The above cycle is repeated until all of the electronic devices have been tested.

To increase the test efficiency and to lower the costs, tester manufacturers have been making faster and faster testers for performing testing. While the test efficiency greatly depends on the overall test time, including the operation time of both the tester and the handler, the handler manufacturers are also seeking faster operating speeds for supplying and retrieving devices to and from the tester, so that the overall testing performance can be improved.

However, the operating speeds of handlers are limited by, for example, the constraints of the mechanical structures, in particular the loading/unloading and the interfacing mechanisms. While faster moving of the loading/unloading mechanism enables faster loading and unloading of the devices, it may also result in certain problems such as devices becoming jammed or stuck in the handler, especially under higher operating speeds. When this happens, the testing operation has to be interrupted to solve the problem, and therefore the testing efficiency is reduced. Further, a faster moving loading/unloading mechanism also requires high quality driving motors and precise parts. Therefore, increasing operating speed also increases the costs of handlers.

FIG. 1 is a schematic diagram showing the test time calculation of one typical working cycle for a tester and a test handling apparatus according to a conventional test handler. A typical test cycle includes a loading phase, a testing phase and an unloading phase. In the loading phase, the loading/unloading assembly picks-up the ICs to be tested from the input tray, moves them to the test sites, and places the ICs into the test sockets. In the testing phase, the tester activates to test the ICs and at the same time, the loading/unloading assembly stops. In the unloading phase upon completion of the test, the tester stops and the loading/unloading assembly operates again to retrieve the tested ICs and delivers these to the output tray, and returns to the input tray for picking-up subsequent ICs for testing. The above test cycle is repeated until all of the ICs have been tested.

In this example, the IC device is configured as a quad-site test, i.e. four ICs are tested at the same time with a 0.7 second test time. The handler has the capability of loading/unloading one group of ICs in one test cycle. It takes 1.2 seconds in the loading phase, and 0.8 seconds in the unloading phase.

The term “test time” refers to the time period the tester takes to test one group of ICs; the term “loading time” refers to the time period the loading/unloading assembly takes to pick-up one group of ICs from the input tray, and deliver the ICs to the test sites; and “unloading time” refers to the time the loading/unloading assembly takes to retrieve the ICs from the test sites upon completion of the testing, deliver the tested ICs to the output tray, and move back to the input tray for picking up the next group of ICs for testing. Apparently, the conventional test handler works in such a way that when the handler is moving, either while supplying the ICs to the testing sites or retrieving ICs from the testing sites, the tester is idle. The tester is testing only when the ICs are in the testing sites ready for testing. Under this configuration, the overall test capability represented by Units Per Hour (UPH) can be calculated as:

$$\begin{matrix}{UPH}_{0} = ( number of ICs tested at same time ) \times 3600 sec . / \\ ( loading time + test time + unloading time ) \\ = 4 \times 3600 / ( 1.2 + 0.7 + 0.8 ) \\ ≅ 5333\end{matrix}$$

Tester use rate K₀=(test time)/(cycle time)=0.7/(1.2+0.7+0.8)≅25.9%

Attempts have been made to improve the overall efficiency of test handling apparatus. U.S. Pat. No. 5,805,472 to Fukasawa entitled “Test handler For Semiconductor Devices” discloses a test handler for semiconductor devices which comprises test trays provided with respective identification codes for discriminating from other test trays, the identification codes being read by a reading device arranged respectively at given control sites in the test handler and stored in a control table, and controlled by a control device along with data on the control sites for reading the identification codes. In a test handler according to U.S. Pat. No. 5,805,472, the test trays can be located easily within the test handler to discriminate different lots of ICs. Different lots of ICs can be tested on a continuous basis so that the tester does not have to pause for the change-over of different product lots, therefore the suspension time of the tester can be reduced and the operation efficiency can be improved. While the overall testing efficiency may be improved by reducing the job change-over time, the test time within individual lots of devices remains unimproved.

It is therefore an aim of at least a preferred embodiment of the present invention to provide a test handling apparatus and/or a method for operating a test handler, which is capable of increasing the overall testing efficiency without substantially increasing the manufacturing costs of the handler.

### SUMMARY OF THE INVENTION

In accordance with a first aspect of the invention, there is provided a test handling apparatus for electronic device testing, the apparatus comprises a tester interface for communicating with a tester; at least two device interfaces each of which is connectable to the tester interface through a first connection, and each of which is connectable to a corresponding group of electronic devices through a second connection, wherein one of the first and the second connections is alternately connectable.

The term “tester interface” refers to the mechanism of a test handling apparatus for connecting with a tester for establishing electronic communications. The term “device interface” refers to the mechanism of a test handling apparatus for electrically connecting with electronic devices to be tested. The term “alternately connectable” refers to the situation where the at least two device interfaces are connectable to the tester interface one at a time and the electrical connection is interchangeable therebetween. The term “alternately connectable” also refers to the situation where the at least two device interfaces are connectable to the corresponding electronic devices one group at a time.

In a first embodiment, the first connection is alternately connectable and the second connection is simultaneously connectable.

The term “simultaneously connectable” refers to the situation where the at least two device interfaces are connected to the tester interface at the same time. It also refers to the situation where the at least two device interfaces are able to connect to their corresponding groups of electronic devices at the same time.

Preferably, the test handling apparatus further comprises a switch for alternately connecting the at least two device interfaces to the tester interface.

Preferably, the test handling apparatus further comprises a loading/unloading assembly for simultaneously supplying electronic devices to the at least two device interfaces for testing, and retrieving the electronic devices from the at least two device interfaces upon completion of testing.

Alternatively, the loading/unloading assembly comprises one test arm for simultaneously supplying electronic devices to the at least two device interfaces for testing, and simultaneously retrieving the electronic devices from the at least two device interfaces upon completion of testing.

Alternatively, the loading/unloading assembly comprises at least two independently-operable test arms for alternately supplying electronic devices to the at least two device interfaces for testing, and alternately retrieving electronic devices from the at least two device interfaces upon completion of the testing.

Preferably, the test handling apparatus further comprises a controller associated with the switch for controlling the loading/unloading assembly.

In another embodiment, first connection is simultaneously connectable and the second connection is alternately connectable.

Preferably, the test handling apparatus further comprises a loading/unloading assembly for alternately supplying electronic devices to the at least two device interfaces for testing, and retrieving the electronic devices from the at least two device interfaces upon completion of the testing.

Alternatively, the loading/unloading assembly is movable between an input section for picking up electronic devices and a pre-connecting position adjacent to the at least two device interfaces, and the loading/unloading assembly further includes a test arm for simultaneously carrying electronic devices to the pre-connecting position; and an actuator for alternately supplying electronic devices to the at least two device interfaces for testing.

Alternatively, the loading/unloading assembly comprises at least two independently-operable test arms each for simultaneously carrying electronic devices to the corresponding pre-connecting position, each test arm being movable between an input section for picking up electronic devices and a respective pre-connecting position adjacent to a respective device interface, wherein each of the at least two independently operable test arms has at least one actuator for alternately supplying electronic devices to the at least two device interfaces for testing.

In accordance with a second aspect of the invention, there is provided a test handling apparatus for testing electronic devices, the test handling apparatus comprising an interface for external communications; a first test socket for receiving a first group of electronic devices for testing; a second test socket for receiving a second group of electronic devices for testing; and a switch for alternately connecting the first test socket and the second test socket to the interface.

In accordance with a third aspect of the invention, there is provided a test handling apparatus for testing electronic devices, the test handling apparatus comprises an interface for external communications; a first test socket for receiving a first group of electronic devices for testing and a second test socket for receiving a second group of electronic devices for testing; the first test socket and the second test socket being connected in parallel to the interface; and the first and second test sockets being adapted for alternately receiving the respective first and second groups of electronic devices for testing.

In accordance with a fourth aspect of the invention, there is provided a method for operating a test handling apparatus, the method comprises the steps of, in a primary test cycle, (a) connecting the first group of electronic devices to a tester interface for testing; (b) disconnecting the first group of electronic devices from the tester interface upon completion of the testing; (c) connecting a second group of electronic devices to the tester interface for testing; and (d) disconnecting the second group of electronic devices from the tester interface upon completion of the testing.

Preferably, the method further comprises a step of, before the step (a), loading a first group and a second group of electronic devices to a test site.

Preferably, the method further comprises a step of, after the completion of step (d), unloading the first group and a second group of electronic devices from the test site.

Preferably, the steps (b) and (c) are simultaneously operable.

Preferably, the method further comprises a step of, before the step (a), loading a first group of electronic devices to the test site, and after the completion of step (b), unloading the first group of electronic devices from the test site.

Preferably, the method further comprises a step of, during unloading the first group of electronic devices from the test site, loading a second group of electronic devices to a test site.

Preferably, the method further comprises a plurality of subsequent test cycles repeating the steps of the primary test cycle.

### BRIEF DESCRIPTION OF THE DRAWINGS

FIG. 1 is a schematic diagram showing the test time calculation of one typical working cycle for a conventional test handling apparatus;

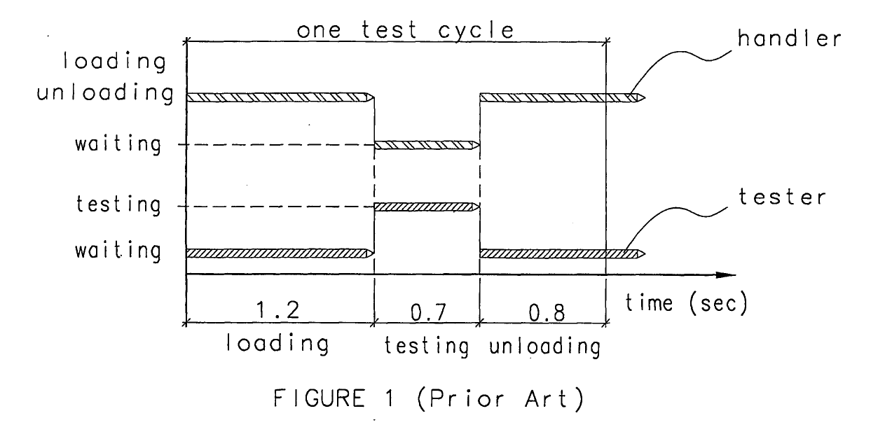

FIG. 2 is a schematic diagram showing the test handling apparatus according to a first embodiment of the present invention;

FIG. 3 is a schematic diagram showing the test time calculation of one typical working cycle for a test handling apparatus according to FIG. 2;

FIG. 4 is a schematic diagram showing the test handling apparatus according to a second embodiment of the present invention;

FIG. 5 is a schematic diagram showing the test time calculation of one typical working cycle for a test handling apparatus according to FIG. 4;

FIG. 6 is a schematic diagram showing the test handling apparatus according to a third embodiment of the present invention;

FIG. 7 is a schematic diagram showing the test time calculation of one typical working cycle for a test handling apparatus according to FIG. 6; and

FIG. 8 is a schematic diagram showing the test handling apparatus according to a fourth embodiment of the present invention.

### DETAILED DESCRIPTION OF THE PREFERRED EMBODIMENTS

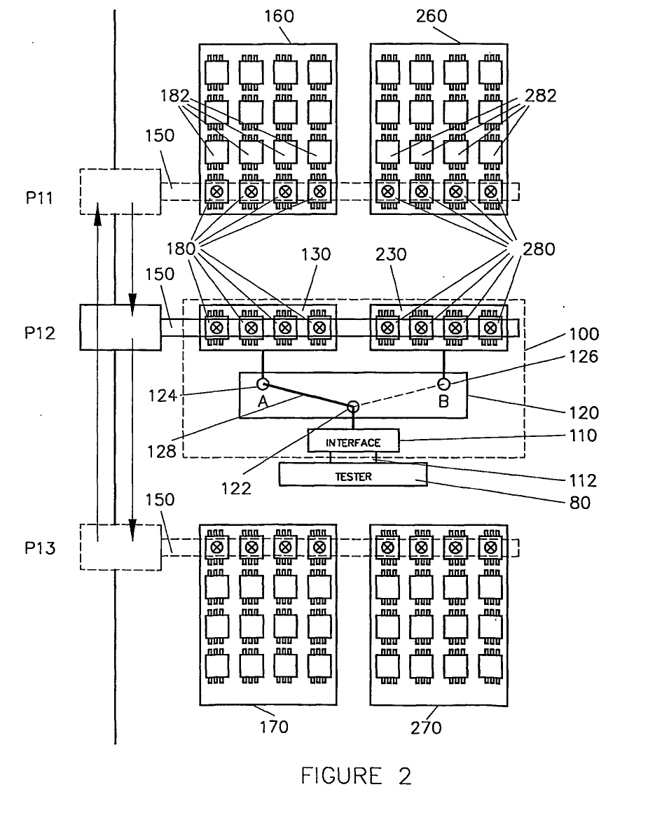

With reference to FIG. 2, a test handling apparatus 100 according to a first embodiment of the present invention comprises a tester interface 110, a first connection which is a switch 120, a first device interface in the form of a first test socket 130 and a second device interface in the form of a second test socket 230. The interface 110 may comprise a docking plate or receptacle 112, depending on the test set up condition for external communications with a tester 80 by either direct docking or cable connection. The interface 110 is electrically connected to the switch 120 by a connector 122. The switch 120 is a 1×2 change-over switch which is operable to alternate the electrical connection 128 from connectors 122-124 (position A), to connectors 122-126 (position B). Connectors 124 and 126 are electrically connected to the first test socket 130 and the second test socket 230 respectively. The test handling apparatus 100 further comprises a loading/unloading assembly 150, which is movable between the input sections 160 and 260 (position P11), the test sockets 130 and 230 (position P12), and the output sections 170 and 270 (position P13).

In this embodiment, the electronic devices such as semiconductor ICs are configured under “quad-site” testing, i.e. a group of four ICs are configured for parallel testing. A person skilled in the art would appreciate the usage of the present invention under other test configurations, such as “single-site” testing (one IC tested at a time) or “dual-site” testing (two ICs tested simultaneously), as well as other test configurations.

In operation, the loading/unloading assembly 150 picks-up a first batch of two groups of ICs 180 and 280 (4×2=8 ICs) at one time from the input sections 160 and 260, and supplies the eight ICs 180 and 280 to the respective first and second test sockets 130 and 230, simultaneously. Concurrently, the switch 120 turns to position A, i.e. electrically connects the interface 110 to the first test socket 130.

When the eight ICs 180 and 280 are connected with their respective test sockets 130 and 230, the tester activates to test the first group of ICs 180 in the first test socket 130. Upon completion of the testing of the first group of ICs 180, the tester 80 pauses, and the switch 120 switches over the connection 128 from position A to position B. The tester 80 then re-activates to test the second group of ICs 280 in the second test socket 230. The loading/unloading assembly 150 stops during the testing of the first group of ICs 180, the switch connections change over from position A to Position B, and the testing of the second group of ICs 280 occurs.

Upon completion of the testing of the second group of ICs 280, the loading/unloading assembly 150 operates again to retrieve the ICs 180 and 280 from the first and second test sockets 130 and 230 and delivers them to the respective output sections 170 and 270. The loading/unloading assembly then moves back to the input section 160 and 260 to pick up the subsequent batch of ICs 182, 282 for testing. The whole test cycle of testing the first batch of 8 devices 180 and 280 is now completed.

The above test cycle may be repeated continuously until all of the ICs have been tested.

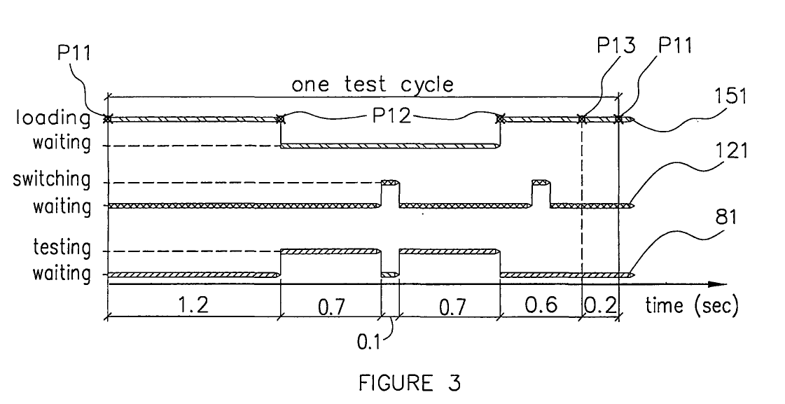

As shown in FIG. 3, charts 151, 121 and 81 represent the operation of the loading/unloading assembly 150, the switch 120 and the tester 80, respectively. Based on the same test set up condition of the conventional test handler as described previously, i.e. the IC devices are configured under quad-test testing with a 0.7 second test time, the loading time is 1.2 seconds, and the unloading time is 0.8 seconds, the UPH can therefore be calculated as:

$$\begin{matrix}{UPH}_{1} = ( number of devices tested at same time ) \times 3600 sec . / \\ ( loading time + test time + switch time + \\ test time + unloading time ) \\ = 4 \times 2 \times 3600 / ( 1.2 + 0.7 + 0.1 + 0.7 + 0.8 ) \\ ≅ 8229\end{matrix}$$

$$\begin{matrix}Tester use rate K1 = ( test time ) / \\ ( loading time + test time + switch time + \\ test time + unloading time ) \\ = 0.7 \times 2 / ( 1.2 + 0.7 + 0.1 + 0.7 + 0.8 ) \\ = 40 \%\end{matrix}$$

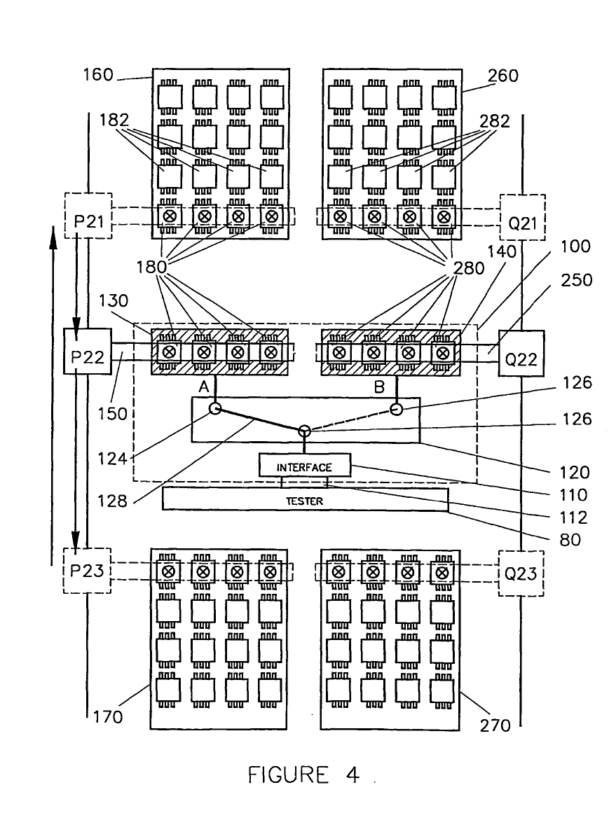

Reference is now made to FIG. 4. The test handling apparatus 100 according to a second embodiment of the present invention includes a tester interface 110, a switch 120, a first device interface in the form of a first test socket 130 and a second device interface in the form of a second test socket test socket 230. The interface 110 is electrically connected to a switch 120 at connector 122. The switch 120 is a 1×2 change-over switch which is operable to alternate the electrical connection 128 from connectors 122-124 (position A), to connectors 122-126 (position B). Connectors 124 and 126 are electrically connected to the first test socket 130 and the second test socket 230 respectively.

In this embodiment, the test handling apparatus 100 further comprises a first loading/unloading assembly 150 and a second loading/unloading assembly 250. The first loading/unloading assembly 150 is movable between a first input section 160 (position P21), the first test socket 130 (position P22), and a first output section 170 (position P23). The second loading/unloading assembly 250 is movable between a second input section 260 (position Q21), the second test socket 230 (position Q22), and a second output section 270 (position Q23). The second loading/unloading assembly 250 is movable independently of the first loading/unloading assembly 150.

Upon starting of the test, the first and second loading/unloading assemblies 150, 250 move to their respective input sections 160, 260 to pick-up the respective groups of ICs 180, 280, and deliver these to the respective test sockets 130, 230. The switch 120 first connects the interface 110 to the first test socket 130 (position A). The tester is then activated to start the test for ICs 180. Upon completion of the test, the tester 80 pauses, and the switch 120 switches over the connection 128 from position A to position B. The tester is then re-activated to test the ICs 280 in the second test socket 230. Since the first and the second loading/unloading assemblies 150, 250 are independently movable, during the testing of the second group of ICs 280, the first loading/unloading assembly 150 retrieves the ICs 180 from the first test socket 130 and delivers the ICs 180 to the first output section 170. The first loading/unloading assembly 150 then moves back to the first input section 160 to pick-up the subsequent ICs 182 and delivers them to the first test socket 130 for the next testing cycle. Similarly, upon completion of the testing for ICs 280 in the second test socket 230, the tester pauses, the switch 120 changes the connection 128 back to position A, and the second loading/unloading assembly 250 retrieves the ICs 280 from the second test sockets 230 and delivers the ICs 280 to the second output section 270. The second loading/unloading assembly 250 then moves back to the second input section 260 to pick-up the subsequent ICs 282 and delivers them to the second test socket 230 for the next test cycle.

The above process may be repeated until all of the ICs have been tested.

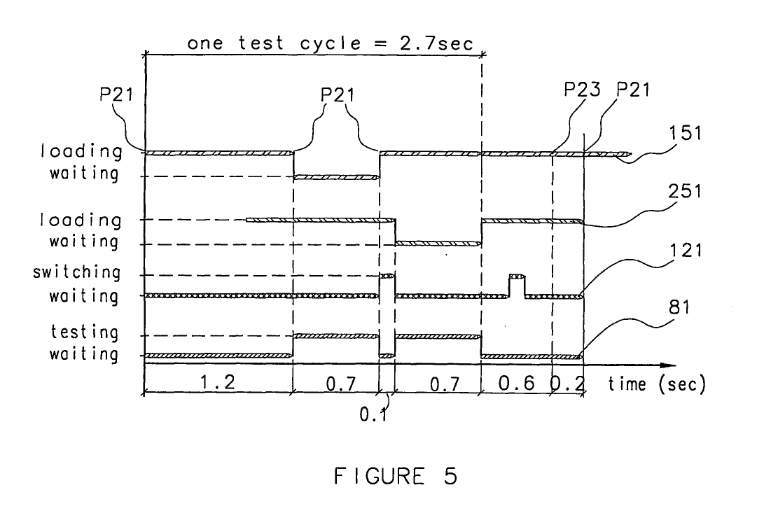

As shown in FIG. 5, based on the same test set up condition of the conventional test handler described previously, i.e. the IC devices are configured under quad-test testing with a 0.7 second test time and the test arm cycle time is 2.0 seconds, the UPH can be calculated as follows:

$$\begin{matrix}{UPH}_{2} = ( number of devices tested at same time ) \times 3600 sec . / \\ ( cycle time + test time ) \\ = 4 \times 2 \times 3600 / ( 1.2 + 0.7 + 0.8 ) \\ ≅ 10667\end{matrix}$$

$$\begin{matrix}Tester use rate K2 = ( test time \times 2 ) / ( cycle time + test time ) \\ = 0.7 \times 2 / ( 1.2 + 0.7 + 0.8 ) \\ ≅ 51.8 \%\end{matrix}$$

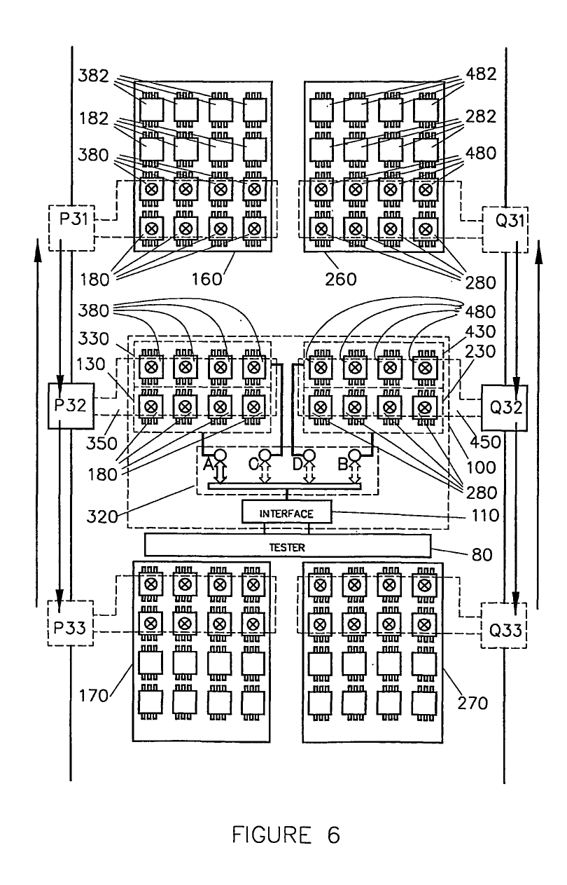

A third embodiment of the present invention is shown in FIG. 6. A test handling apparatus according to a third embodiment of the present invention comprises four test sockets 130, 230, 330 and 430, and a corresponding 1×4 change-over switch 320 adapted for alternating electrical connections from the interface 110 to any one of the four test sockets 130, 230, 330 and 430 (positions A, B, C and D, respectively). The test handling apparatus further comprises first and second loading/unloading assemblies 350, 450, each of which is capable of carrying two groups of ICs 180, 380 and 280, 480 (4×2=8 ICs per group) at a time, respectively. The first loading/unloading assembly 350 is movable between a first input section 160 (position P31), the test sockets 130, 330 (position P32), and a first output section 170 (position P33). The second loading/unloading assembly 450 is independently movable between a second input section 260 (position Q31), the test sockets 230, 430 (position Q32), and a second output section 270 (position Q33).

Upon starting of the test, the first and the second loading/unloading assemblies 350, 450 move to their respective input section 160, 260 and pick-up the respective groups of ICs 180, 380 and 280, 480 and deliver these to the respective test sockets 130, 330 and 230, 430. The switch 320 is first operated to connect the interface 110 to the first test socket 130 (position A). The tester 80 is then activated to start the test for ICs 180. Upon completion of the test, the tester pauses and the switch 120 is actuated to change the connection to the third test socket 330 (position C) and the tester reactivates to test the corresponding ICs 380. Upon completion of the testing of ICs 380, the tester pauses and the switch 320 is actuated to change the connection to the second test socket 230 (position B) and the tester reactivates to test the corresponding ICs 280. Upon completion of the testing of ICs 280, the tester pauses and the switch 320 is activated to change the connection to the fourth test socket 430. The tester reactivates to test the corresponding ICs 480. Concurrently, the first loading/unloading assembly 350 is re-activated to retrieve the tested ICs 180 and 380 together from the first and the third test sockets 130 and 330, and delivers them to the first output section 170. The first loading/assembly 350 then moves back to the first input section 160 to pick-up the next two groups of ICs 182, 382 for testing. Upon completion of the testing of ICs 280 and 480, the second loading/unloading assembly 250 works in a similar manner as the first loading/unloading assembly 150 to deliver the ICs 280 and 480 to the second output section 270 and moves back to the second input section 260 to pick-up the next two groups of ICs 282, 482 for the next cycle of operation. The above cycle may be repeated until all of the ICs have been tested.

The third embodiment may be suitable to minimize tester idle time which is encountered with the second embodiment. By introducing more test sockets and a corresponding multi-way change-over-switch, the test handling apparatus is capable of meeting requirements for testing of different types of IC or other electronic devices. For example, to maximize the usage of the tester without subsequently increasing the carrying speed (i.e. shortening the cycle time) of the loading/unloading assembly, depending on the various test set up conditions, the test handling apparatus may have 6, 8 or more test sockets and a corresponding 6-way, 8-way or multi-way change-over switch for alternating the electrical connections from the interface to any of the 6, 8 or more test sockets. Within one cycle of movement of the loading/unloading assembly, the tester is able to test more groups of ICs using the above configuration of the switch and test sockets. As such, the overall test efficiency can be maximized.

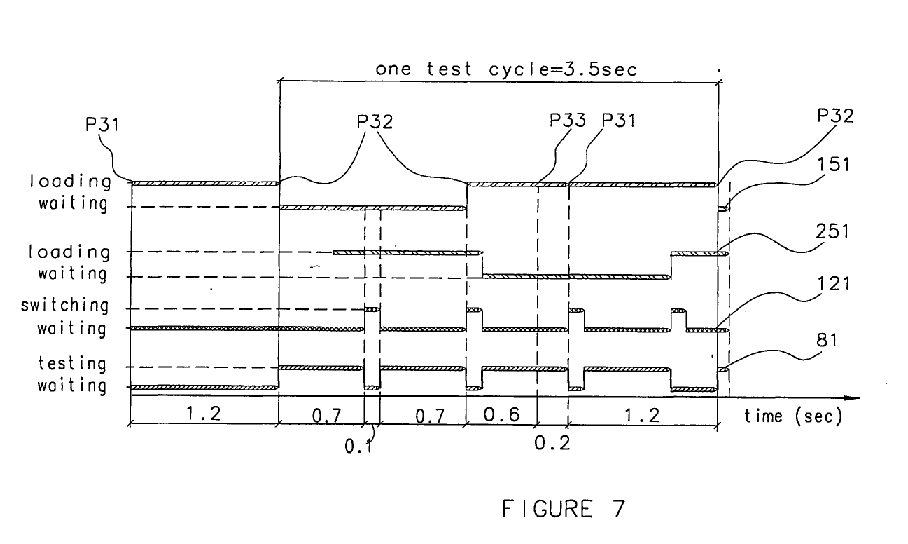

As shown in FIG. 7, based on the same test set up condition of the conventional test handler as described previously, i.e. the IC devices are configured under quad-test testing with a 0.7 second test time and the test arm cycle time is 2.0 seconds, the UPH can be calculated as follows:

$$\begin{matrix}\begin{matrix}{UPH}_{3} = ( number of devices tested at same time ) \times 3600 sec . / \\ ( cycle time + t 61 + switch time + t62 ) \\ = 4 \times 4 \times 3600 / ( 2.0 + 0.7 + 0.1 + 0.7 ) \\ ≅ 16457\end{matrix} \\ \begin{matrix}Tester use rate K3 = ( test time ) / \\ ( test time + cycle time + switch time ) \\ = 0.7 \times 4 / ( 2.0 + 0.7 \times 2 + 0.1 ) \\ = 80 \%\end{matrix}\end{matrix}$$

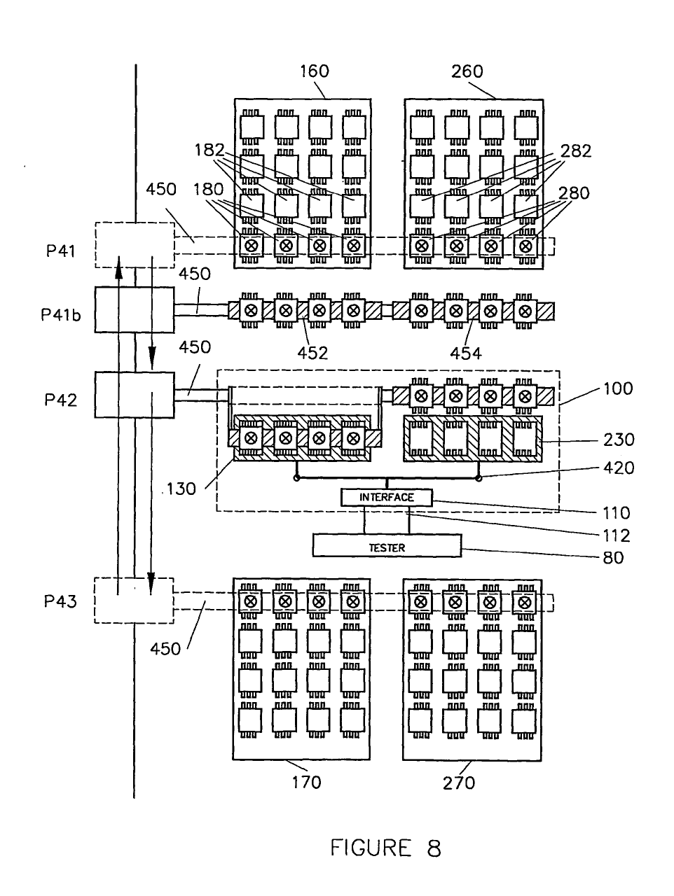

Reference is now made to FIG. 8. A test handling apparatus according to a fourth embodiment of the present invention comprises an interface 110, a first connection 420, a first test socket 130 and a second test socket 230. Rather than utilizing a change-over switch like that used in the first, second and the third embodiments, the first connection 420 in this fourth embodiment is a direct connection cable which connects the first and second test sockets 130 and 230 in parallel with the interface 110, i.e. the interface 110 is connected to the first and second test sockets 130 and 230 simultaneously.

In this embodiment, the test handling apparatus further includes a loading/unloading assembly 450 having thereon a first actuator 452 and a second actuator 454. The first actuator 452 is capable of moving relative to the loading/unloading apparatus 450. Similarly, the second actuator 454 is also movable relative to the loading/unloading assembly 450, and is independently movable relative to the first actuator 452.

Upon starting of the test cycle, the loading assembly 450 carrying the first and the second actuators 452, 454 picks-up a first batch of two groups of ICs 180 and 280 (4×2=8 ICs) simultaneously from the input sections 160 and 260 (position P41), and moves to a pre-loading position P42 adjacent to the first and the second test sockets 130 and 230. The loading/unloading assembly 450 stops at position P42, and the first actuator 452 activates to bring the first group of ICs 180 into contact with the first test socket 130 for testing. Upon completion of the testing of the ICs 180 at the first test socket 130, the tester pauses and the first actuator 452 retrieves the first group of ICs 180 from the first test socket 130, and concurrently, the second actuator 454 activates to bring the second group of ICs 280 into contact with the second test socket 230 for testing. Upon completion of the testing of the second group of ICs 280, the tester pauses and the second actuator 454 retrieves the second group of ICs 280 from the second test socket 230 and the loading/unloading assembly moves with the first and the second groups of ICs 180, 280 and delivers these ICs into the output section 170, 270 (position P43). Following this, the loading/unloading assembly moves back to the input sections 160, 260 to pick-up the next groups of ICs 182, 282. The whole test cycle of testing the first batch of 8 devices 180 and 280 is now completed.

The above test cycle may be repeated continuously until all of the ICs have been tested.

It can be seen that in this embodiment, the ICs are alternately connected through the respective test sockets to the interface for testing. Instead of utilizing a change-over switch for alternately connecting the different groups of ICs to the interface, this embodiment uses independently movable actuators for effecting alternate connections between the ICs and the interface. Calculation of the UPH can be derived from the disclosures of the first embodiment as referred to FIG. 3. A person skilled in the art would also appreciate the apparent variations of this embodiment to achieve the similar result of the present invention. For example, there might be two or more independently movable loading/unloading assemblies each carrying two or more actuators for alternately connecting the corresponding group of ICs for testing. Each actuator may also be configured for simultaneously carrying more than one group of ICs and alternately connecting these ICs to the test sockets for testing, as referred to in the alternative derivations for the second and the third embodiments from the first embodiment.

The above describes preferred embodiments of the present invention, and modifications may be made thereto without departing from the scope of the following claims.

1. A test handling apparatus for supplying electronic devices to a tester for testing, the test handling apparatus comprising:
a tester interface for communicating with the tester;
at least two device interfaces each of which is connectable to the tester interface through a first connection, and each of which is connectable to a corresponding group of electronic devices through a second connection;
wherein one of the first and the second connections is alternately connectable.

2. The test handling apparatus as claimed in claim 1, wherein the first connection is alternately connectable and the second connection is simultaneously connectable.

3. The test handling apparatus as claimed in claim 2, wherein the first connection comprises a switch for alternately connecting the at least two device interfaces to the tester interface.

4. The test handling apparatus as claimed in claim 3, further comprising a loading/unloading assembly for supplying electronic devices to the at least two device interfaces for testing, and retrieving the electronic devices from the at least two device interfaces upon completion of testing.

5. The test handling apparatus as claimed in claim 4, wherein the loading/unloading assembly comprises one test arm for simultaneously supplying electronic devices to the at least two device interfaces for testing, and simultaneously retrieving the electronic devices from the at least two device interfaces upon completion of testing.

6. The test handling apparatus as claimed in claim 4, wherein the loading/unloading assembly comprises at least two independently-operable test arms for alternately supplying electronic devices to the at least two device interfaces for testing, and alternately retrieving electronic devices from the at least two device interfaces upon completion of the testing.

7. The test handling apparatus as claimed in claim 4, further comprising a controller associated with the switch for controlling the loading/unloading assembly.

8. The test handling apparatus as claimed in claim 1, wherein the first connection is simultaneously connectable and the second connection is alternately connectable.

9. The test handling apparatus as claimed in claim 7, further comprising a loading/unloading assembly for alternately supplying electronic devices to the at least two device interfaces for testing, and retrieving the electronic devices from the at least two device interfaces upon completion of the testing, wherein the loading/unloading assembly is movable between an input section for picking up electronic devices and a pre-connecting position adjacent to the at least two device interfaces, the loading/unloading assembly further comprising:
a test arm for simultaneously carrying electronic devices to the pre-connecting position; and
an actuator for alternately supplying electronic devices to the at least two device interfaces for testing.

10. The test handling apparatus as claimed in claim 7, further comprising a loading/unloading assembly for alternately supplying electronic devices to the at least two device interfaces for testing, and retrieving the electronic devices from the at least two device interfaces upon completion of the testing, wherein the loading/unloading assembly comprises at least two independently-operable test arms each for simultaneously carrying electronic devices, each test arm being movable between an input section for picking up electronic devices and a respective pre-connecting position adjacent to a respective device interface,
wherein each of the at least two independently operable test arms has at least one actuator for alternately supplying electronic devices to the at least two device interfaces for testing.

11. A test handling apparatus for testing electronic devices, the test handling apparatus comprising:
an interface for external communications;
a first test socket for receiving a first group of electronic devices for testing;
a second test socket for receiving a second group of electronic devices for testing; and
a switch for alternately connecting the first test socket and the second test socket to the interface,
wherein the first test socket and the second test socket receive electronic devices at substantially the same time.

12. The test handling apparatus as claimed in claim 11, further comprising a loading/unloading assembly for supplying the first group of electronic devices to the first test socket and the second group of electronic devices to the second test socket for testing, and retrieving the first group of electronic devices from the first test socket and the second group of electronic devices from the second test socket upon completion of the testing, wherein the loading/unloading assembly comprises a test arm for simultaneously supplying the first and the second groups of electronic devices to the respective first and second test sockets for testing, and simultaneously retrieving the first and second groups of electronic devices from the first and second test sockets upon completion of the testing.

13. The test handling apparatus as claimed in claim 11, further comprising a loading/unloading assembly for supplying the first group of electronic devices to the first test socket and the second group of electronic devices to the second test socket for testing, and retrieving the first group of electronic devices from the first test socket and the second group of electronic devices from the second test socket upon completion of the testing, wherein the loading/unloading assembly comprises:
a first test arm for supplying the first group of electronic devices to the first test socket for testing, and retrieving the first group of electronic devices from the first test arm upon completion of the testing; and
a second test arm for supplying the second group of electronic devices to the second test socket for testing, and retrieving the second group of electronic devices from the second test arm upon completion of the testing,
wherein the first test arm and the second test arm are independently actuatable for supplying and retrieving the electronic devices.

14. A method of automatically testing electronic devices comprising the steps of:
in a primary test cycle,
(a) connecting a first group of electronic devices to a tester interface for testing;
(b) disconnecting the first group of electronic devices from the tester interface upon completion of the testing;
(c) connecting a second group of electronic devices to the tester interface for testing;
(d) disconnecting the second group of electronic devices from the tester interface upon completion of the testing.

15. The method as claimed in claim 14, further comprising a step of, before the step (a), loading a first group and a second group of electronic devices to a test site.

16. The method as claimed in claim 14, further comprising a step of, after the completion of step (d), unloading the first group and a second group of electronic devices from the test site.

17. The method as claimed in claim 14, wherein the steps (b) and (c) are simultaneously operable.

18. The method as claimed in claim 14, further comprising a step of, before the step (a), loading a first group of electronic devices to the test site, and after the completion of step (b), unloading the first group of electronic devices from the test site.

19. The method as claimed in claim 18, further comprising a step of, during unloading the first group of electronic devices from the test site, loading a second group of electronic devices to a test site.

20. The method as claimed in claim 14, further comprising a plurality of subsequent test cycles repeating the steps of the primary test cycle.
